(19) United States
(12) Patent Application Publication
(10) Pub. No.: US 2024/0326230 A1
(43) Pub. Date: Oct. 3, 2024

(54) STOWABLE WORKSTATION AND ROLLING TOOLBOX DEVICE, SYSTEM, AND METHOD

(71) Applicant: Findlay Machine & Tool, LLC, Findlay, OH (US)

(72) Inventors: Nickolas Reinhart, Sarasota, FL (US); Joe Klein, Findlay, OH (US); Ben Sayalith, Findlay, OH (US)

(21) Appl. No.: 18/623,299

(22) Filed: Apr. 1, 2024

Related U.S. Application Data
(60) Provisional application No. 63/493,234, filed on Mar. 30, 2023.

(51) Int. Cl. B25H 1/04; B25H 1/00; B25H 1/12

(52) U.S. Cl. CPC B25H 1/04; B25H 1/0057; B25H 1/12

(57) ABSTRACT

The present disclosure relates to a stowable workstation and a work system. The stowable workstation includes a tabletop with a work surface and a stowing surface, along with a plurality of receiving apertures. A plurality of legs are removably coupled to the tabletop in a supporting position for use and a stowed position for storage. The work system includes the stowable workstation and a rolling toolbox with at least one wheel, a hollow body, and a lid with a recess designed to receive the stowable workstation when not in use. Methods for using the stowable workstation and the work system are also disclosed, including steps for transitioning the workstation between its supporting and stowed positions, and for integrating the workstation with the rolling toolbox to facilitate transportation and storage. Advantageously, the stowable workstation addresses the need for a versatile, portable, and easily stowable workstation with an integrated tool storage capability.

### CROSS-REFERENCE TO RELATED APPLICATIONS

This application claims the benefit of U.S. Provisional Application No. 63/493,234, filed on Mar. 30, 2023. The entire disclosure of the above application is incorporated herein by reference.

### FIELD

The present technology relates to workstations, and, more particularly, to a system and method for stowing and transporting a stowable workstation with an integrated rolling toolbox.

### INTRODUCTION

This section provides background information related to the present disclosure which is not necessarily prior art.

In many industries, professionals and other individuals alike require workstations for completing certain activities. Workstations are often configured as static, heavy tables that are not designed for easy movement or storage. Such workstations can be cumbersome and occupy significant amount of space in an area, which is particularly problematic in smaller work environments or when the workstation needs to be transported to various locations. Tools and materials may also be stored separately from the workstation, leading to inefficiencies and increased time spent retrieving necessary items. This separation can also increase the risk of misplacing or losing tools, which can be costly and disruptive to a workflow.

Workstations with fixed dimensions and features may limit the type of work that can be performed and do not cater to the diverse needs of different users. The lack of modularity and adaptability in the workstation may restrict its utility and may fail to provide a comprehensive solution for a range of applications. Portability of the workstation and one or more associated toolboxes can be a challenging task. One problem in transporting the workstation and toolboxes is the risk of damage or breakage. The workstation and equipment may shift or collide during transport, leading to scratches, dents, or even irreparable damage. Some workstations and toolboxes are designed for specific purposes and require precise handling, such as delicate electrical components or precision tools. If not transported correctly, these items may become unusable, and replacements can be costly and time-consuming to acquire. Therefore, proper packaging, securing, and handling techniques are necessary to avoid damage during transport.

Another issue with transporting workstations and toolboxes is the risk of theft. These items can be expensive and may contain valuable tools or equipment, making them attractive targets for thieves. Even if the equipment is insured, the loss of tools can be disruptive and costly to the business. Therefore, it's crucial to take necessary precautions such as using locks, choosing a secure method of transport, and avoiding leaving the equipment unattended.

Accordingly, there is a continuing need for a workstation that is portable and stowable with an integrated storage capability, allowing for quick and easy transition between different configurations, and provides modularity to accommodate a variety of tasks and tools.

### SUMMARY

In concordance with the instant disclosure, a workstation that is portable and stowable with an integrated storage capability, allowing for quick and easy transition between different configurations, and provides modularity to accommodate a variety of tasks and tools, has surprisingly been discovered. The present technology includes articles of manufacture, systems, and processes that relate to stowable workstations and mobile tool storage, providing enhanced portability, organization, and adaptability for various work environments.

In certain embodiments, a stowable workstation is provided. The stowable workstation may include a tabletop with a work surface, a stowing surface, and a plurality of receiving apertures. The stowable workstation may also include a plurality of legs that are designed to be removably coupled to the tabletop in both a supporting position, where the legs are coupled to the receiving apertures, and a stowed position, where the legs are coupled to the stowing surface.

In certain embodiments, a work system is provided. The work system may include the stowable workstation, as described herein, along with a rolling toolbox. The rolling toolbox may include at least one wheel, a hollow body, and a lid that may be designed to couple with the hollow body. The lid may include a recess formed in the lid, which may be configured to receive the tabletop of the stowable workstation when the legs are in the stowed position.

In certain embodiments, methods of using a stowable workstation as well as a work system including the stowable workstation and a rolling toolbox, are provided. Such methods may include providing a stowable workstation and performing actions that include either coupling the plurality of legs to the stowing surface of the tabletop to achieve the stowed position or coupling the legs to the receiving apertures to achieve the supporting position. These methods may further include actions such as inserting the stowable workstation into the recess of the lid to load it onto the rolling toolbox or removing the stowable workstation from the recess to unload it, with the additional step of coupling the legs to the stowing surface of the tabletop prior to insertion into the recess.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top perspective view of a stowable workstation, according to an embodiment of the present disclosure;

FIG. 2 is a bottom perspective view of the stowable workstation shown in FIG. 1;

FIG. 3 is a front elevational view of the stowable workstation shown in FIG. 1;

FIG. 4 is a rear elevational view of the stowable workstation shown in FIG. 1;

FIG. 5 is a side elevational view of the stowable workstation shown in FIG. 1;

FIG. 6 is a top plan view of the stowable workstation shown in FIG. 1;

FIG. 7 is a bottom plan view of the stowable workstation shown in FIG. 1;

FIG. 8 is a top perspective view of the stowable workstation shown in FIG. 1, shown in a supporting position;

FIG. 9 is a bottom perspective view of the stowable workstation shown in FIG. 8;

FIG. 10 is an exploded view of the stowable workstation shown in FIG. 8;

FIG. 11 is a close-up of a flanged end of a leg of the of the stowable workstation, as shown in FIG. 8;

FIG. 12 is a close-up cross-sectional view of the flanged end of the leg received by a receiving aperture of the stowable workstation, as shown in FIG. 8;

FIG. 13 is a top perspective view of a stowable workstation disposed in a lid of a rolling toolbox, according to another embodiment of the present disclosure;

FIG. 14 is a front elevational view of the rolling toolbox as shown in FIG. 13;

FIG. 15 is a cross-sectional view taken along line 15-15, as shown in FIG. 13;

FIG. 16 is an exploded view of the rolling toolbox shown in FIG. 13;

FIG. 17 is a top perspective view of the rolling toolbox without the stowable workstation, according to another embodiment of the present disclosure;

FIG. 18 is a flowchart illustrating a method of using the stowable workstation, according to an embodiment of the present disclosure; and

FIG. 19 is a flowchart illustrating another method of using the work system, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

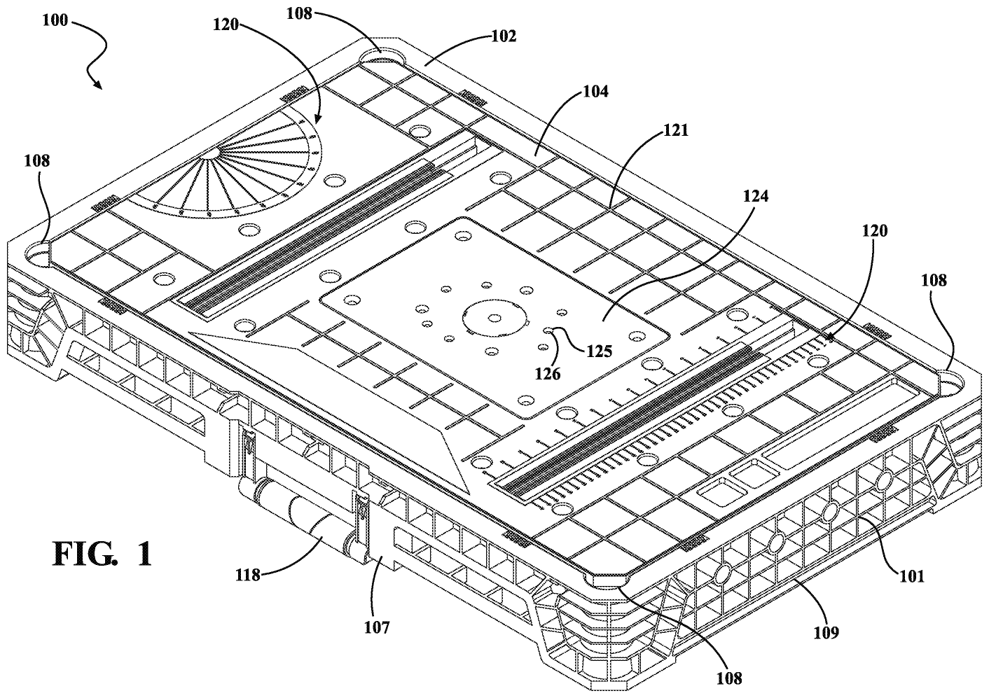

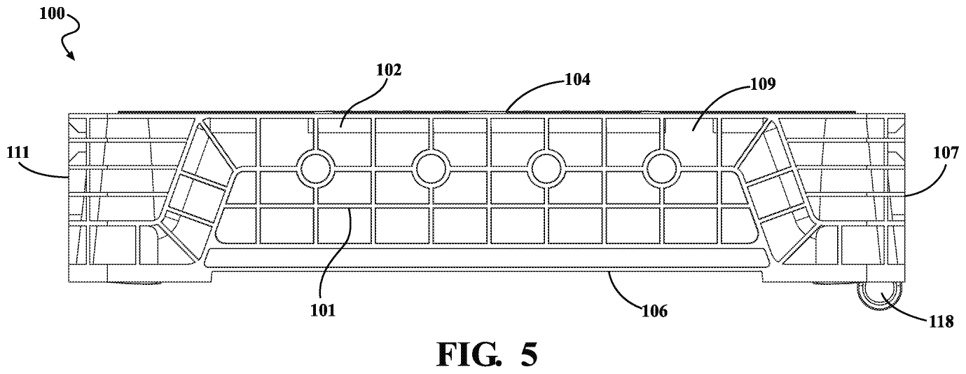

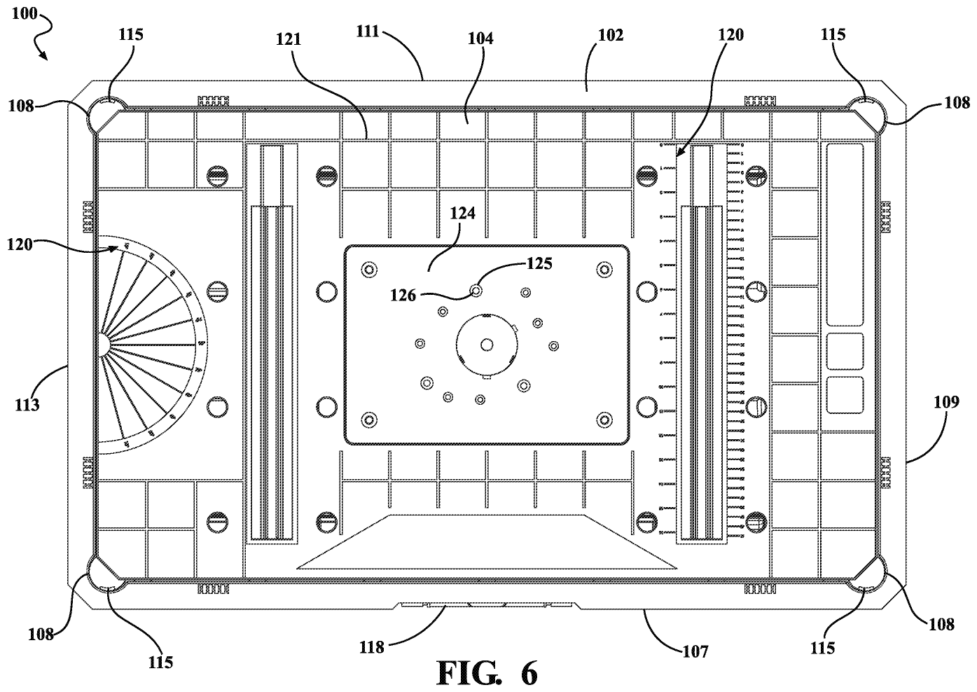

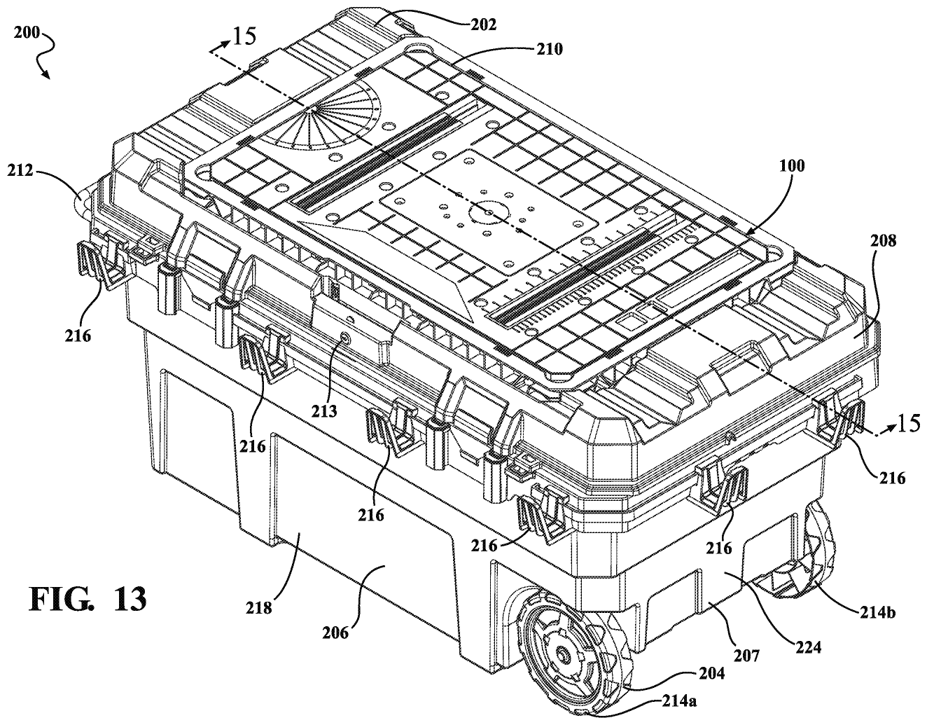

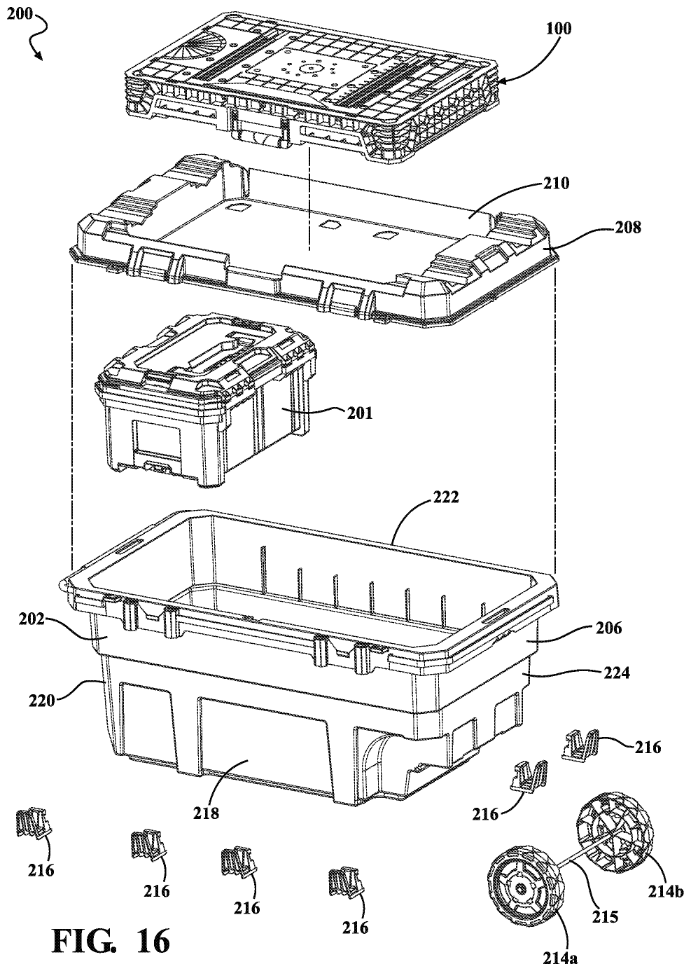

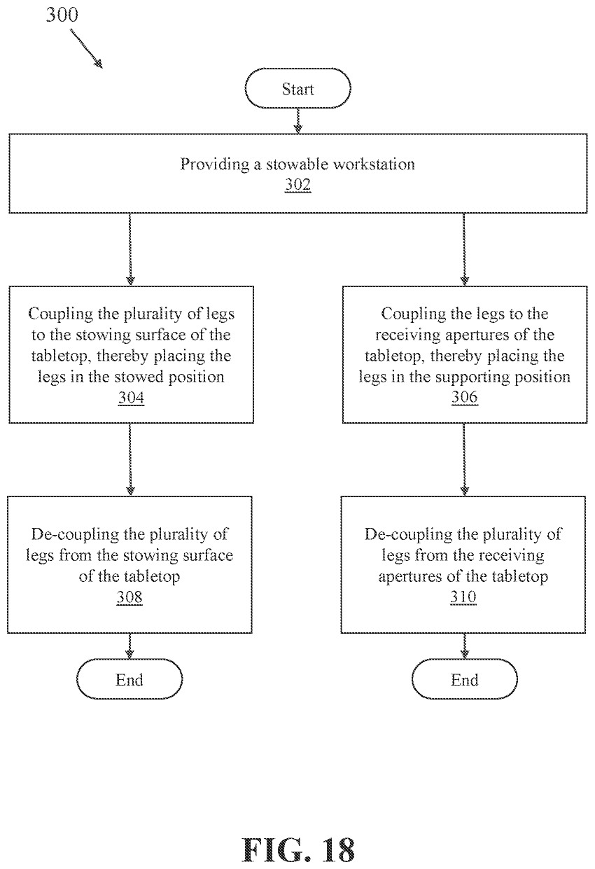

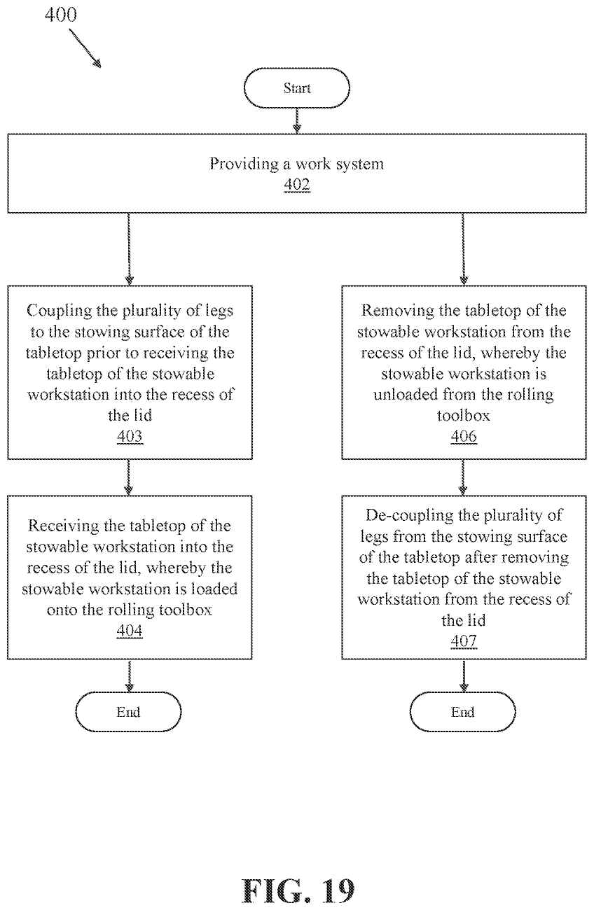

The present technology provides a stowable workstation 100, as shown in accompanying FIGS. 1-12, a work system 200, as shown in the accompanying FIGS. 13-17, as well as methods 300, 400 of using the stowable workstation 100 and a work system 200, as shown in accompanying FIGS. 18-19. Advantageously, the stowable workstation 100 provides a working area that is transportable and easily stowable in an integrated storage system.

According to certain embodiments, a stowable workstation 100 is provided, as shown in FIGS. 1-12. The stowable workstation 100 may include a tabletop 102. The tabletop 102 may include a work surface 104, a stowing surface 106, as well as a plurality of receiving apertures 108 disposed within the tabletop 102. The stowable workstation 100 may further include a plurality of legs 110. Each leg 110 may be configured to be removably coupled to the tabletop 102 in a supporting position 103. The supporting position 103 may include where the legs 110 are engaged with the receiving apertures 108. Alternatively, each leg 110 may be configured to be removably coupled to the tabletop 102 in a stowed position 105. The stowed position 105 may include where the legs 110 are coupled to the stowing surface 106 of the tabletop 102.

The tabletop 102 may include the following aspects. The tabletop 102 may be manufactured of plastic, for example. In certain embodiments, the tabletop 102 may be manufactured by injection molding. Advantageously, manufacturing the tabletop 102 using an injection molding process allows for the features of the tabletop 102 to be unitary and integral. The tabletop 102 may include several sidewalls. More specifically, the tabletop 102 may include a first sidewall 107, a second sidewall 109, a third sidewall 111, and a fourth sidewall 113.

The tabletop 102 may include a plurality of braces 101, as shown in FIGS. 1-5. More specifically, each of the first sidewall 107, the second sidewall 109, the third sidewall 111, and the fourth sidewall 113 may include the plurality of braces 101 to provide strength and support for the work surface 104 of the tabletop 102 when in use. The plurality of braces 101 may be disposed in various shapes and formulations, including X-formulations, V-formulations, T-formulations, and combinations thereof. Advantageously, the plurality of braces 101 provide additional strength to the tabletop 102 and the orientation of the braces may enhance the structural integrity of the tabletop 102 and the stowable workstation 100. The braces 101 may also allow for a reduction in material used to form the tabletop 102 resulting in a corresponding reduction in a weight of the tabletop 102 while simultaneously maintaining rigidity and structural integrity. One of ordinary skill in the art may select a suitable configuration for the plurality of braces 101 within the scope of the present disclosure.

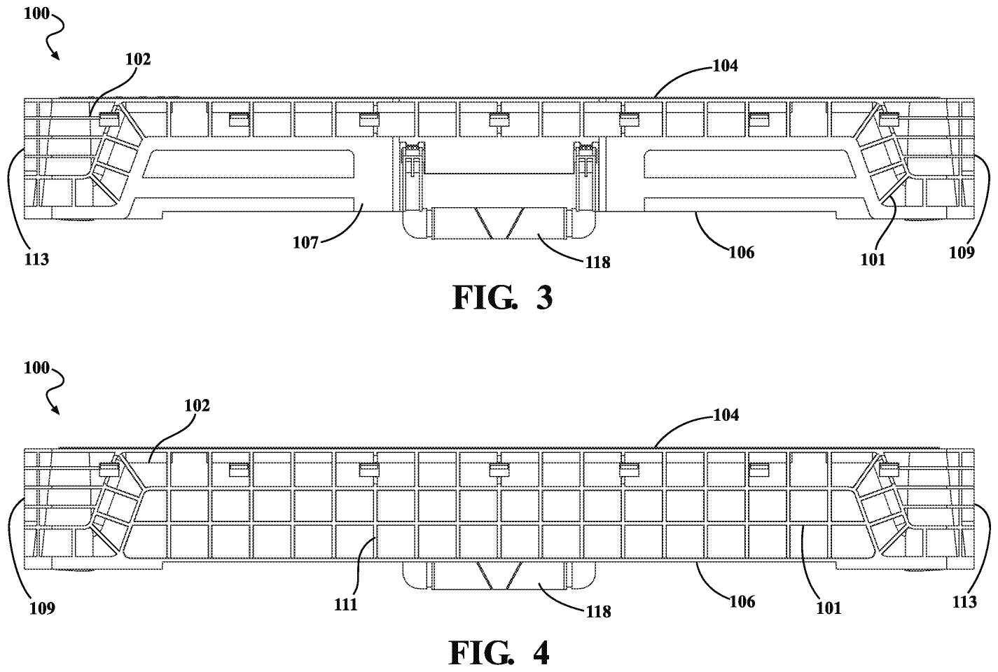

The tabletop 102 may also include a handle 118 disposed along a sidewall of the tabletop 102. As shown in FIGS. 1 and 3, the handle 118 may be disposed along the first sidewall 107 of the tabletop 102. Advantageously, the handle 118 may be configured to facilitate transportation of the stowable workstation 100 and enhance the portability of the stowable workstation 100 by enabling a user to move the stowable workstation 100 between locations easily. The handle 118 may also move between an extended position and a nonextended position relative to the sidewall of the tabletop 102; e.g., the handle 118 may pivot outward from the tabletop 102. This allows the handle 118 to be accessible when needed and to remain out of the way when not in use, thereby not interfering with the work surface 104 of the stowable workstation 100. Advantageously, the capability of moving between an extended position and a nonextended position allows the handle 118 to remain out of the way when the stowable workstation 100 is received in the rolling toolbox 202, as described herein.

In certain embodiments, the handle 118 may be constructed from a durable material such as reinforced plastic or metal to withstand the rigors of frequent transportation and use. Alternatively, the handle 118 may be designed with ergonomic features, such as a rubberized grip, to enhance user comfort during transit. Additionally, the handle 118 may be available in various lengths to accommodate different user preferences and to balance the stowable workstation 100 more effectively during movement. The handle 118 may also incorporate a locking mechanism to secure it in either the extended or nonextended position, providing additional safety and stability during transport or when the stowable workstation 100 is in use. Advantageously, these aspects of the handle 118 offer additional convenience and adaptability to the user, further improving the overall functionality of the stowable workstation 100.

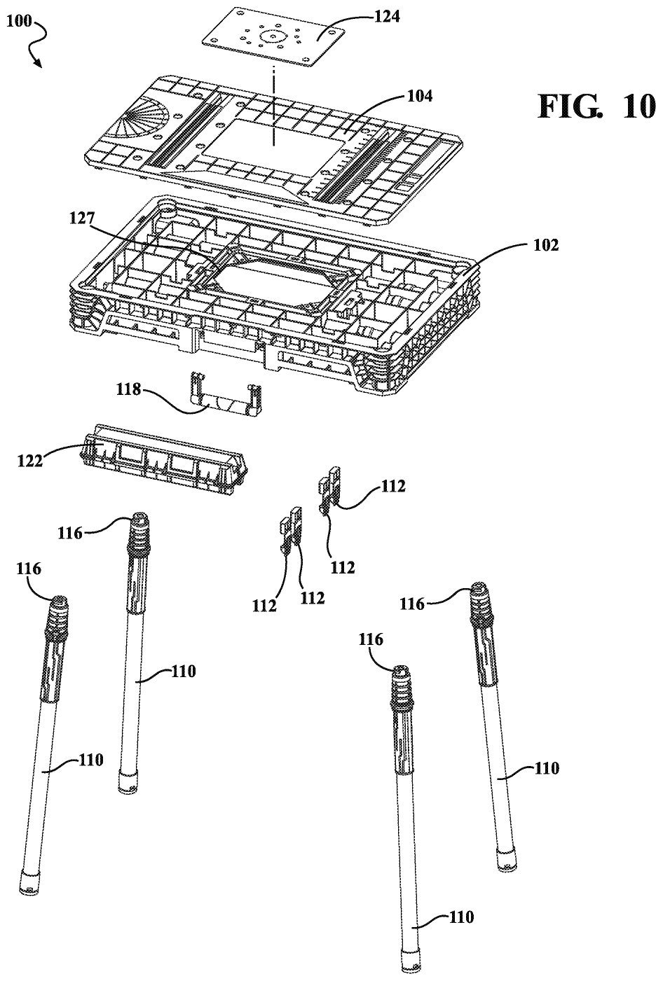

The tabletop 102 may additionally include a mounting plate 124, as shown in FIGS. 1-2 and FIGS. 6-8. The mounting plate 124 may be coupled to the tabletop 102. Further, the mounting plate 124 may be removably disposed to cover a passthrough 127 of the tabletop 102, allowing for the mounting plate 124 to be inserted or removed as needed and providing versatility in the use of the stowable workstation 100, as shown in FIG. 10. The mounting plate 124 may further include several holes 125 for receiving different tools, portions of tools, fasteners, and accessories. The holes 125 also allow for coupling different tools to the mounting plate 124. The holes 125 may be disposed entirely through the mounting plate 124. In another example, the mounting plate 124 may include pins or slots for receiving the tools. Differently configured mounting plates 124 can be configured for use with particular tools. One of ordinary skill in the art may select a suitable mounting plate 124 within the scope of the present disclosure.

The mounting plate 124 may also include a coupling means 126, which may be configured to mount a tool to the mounting plate 124, as shown in FIGS. 1-2 and FIGS. 6-7. As non-limiting examples, the tool may include a drill, a saw, a sander, a router, a heat gun, and combinations thereof. The coupling means 126 may include various mechanisms such as holes and/or pins that may cooperate with various fasteners, clamps, brackets, or magnetic attachments, enabling different tools to be secured to the mounting plate 124, thereby expanding the functionality of the stowable workstation 100 and allowing for a more efficient workflow. For example, the coupling means 126 may include adjustable clamps coupled to the mounting plate 124 that may be used to grip a body of the respective tool. These clamps may have a screw-tightening mechanism to accommodate tools of different sizes and provide a secure hold. As shown in the embodiment depicted in the figures, the coupling means 126 may include a plurality of holes 125 in the mounting plate 124 that can receive one or more portions of a tool and/or receive one or more fasteners used to secure the tool to the mounting plate 124. Further examples include various brackets, locking pins, and/or magnetic attachments and the like that may be to ensure the tool remains stationary during use of the stowable workstation 100. In certain embodiments, the coupling means 126 may include magnets that are embedded within the mounting plate 124 and configured to hold metal tools in place, allowing for quick tool changes and a secure hold. The coupling means 126 may include hook and loop straps for lighter tools or accessories. The coupling means 126 provides a reversible and adaptable way to fasten a tool to the work surface 104, providing for ease of use, adaptability, and allowing the stowable workstation 100 to cater to a wide range of tools and user preferences. One of ordinary skill in the art may select suitable coupling means 126 within the scope of the present disclosure.

The work surface 104 of the tabletop 102 may include the following aspects. The work surface 104 may be defined by an area bordered by each of the first sidewall 107, the second sidewall 109, the third sidewall 111, and the fourth sidewall 113, with reference to FIGS. 1, 6, and 8. The work surface 104 of the tabletop 102 may be designed to allow the user to work off of the stowable workstation 100. The work surface 104 may include indicia 120, as shown in FIGS. 1 and 6. The indicia 120 may be disposed on the work surface 104, along an entirety of the work surface 104, or along a portion of the work surface 104. The indicia 120 may further be disposed around the mounting plate 124 of the tabletop 102 and/or the indicia 120 may be disposed on the mounting plate 124. The indicia 120 may be molded into, stamped, inset, and/or engraved in the work surface 104. The indicia 120 may include one or more predefined length measurements and/or one or more predefined angle measurements, such as those shown in the embodiment depicted in FIG. 6. The predefined length measurement may include a ruler depiction showing measurements from 0-inches to 12-inches. Alternatively, the predefined length measurement may include markings indicating both inches and centimeters. The predefined angle measurement may include a protractor depiction illustrating measurements from 0-degrees to 180-degrees, for example. Advantageously, the indicia 120 may assist the user in performing tasks that require precision, such as measuring, cutting, or aligning materials, without the need for separate tools, all within the vicinity of the stowable workstation 100. Desirably, the user may have everything they need on the work surface 104 to execute one or more particular workflows. One of ordinary skill in the art may select suitable indicia 120 to place on the work surface 104 within the scope of the present disclosure.

The work surface 104 may further include a plurality of indents 121, as shown in FIGS. 1, 6, and 8. The plurality of indents may be disposed along the work surface 104. The plurality of indents 121 may include a checkered pattern. Alternatively, the plurality of indents 121 may include another pattern. The plurality of indents 121 allow the user to create shapes and other markings on paper using a pencil. The plurality of indents 121 also provide the capability of the user to create linear lines on paper when using the work surface 104 of the tabletop 102. The indents 121 may form repeats of a predetermined measurement; e.g., 1 inch squares. One of ordinary skill in the art may select a suitable configuration for the plurality of indents 121 within the scope of the present disclosure.

The indicia 120 on the work surface 104 may include additional visual aids such as color-coded markings that enhance visibility in various conditions when the stowable workstation 100 is in use. The work surface 104 may also include inlays or changeable overlays with printed measurements, which may be readily replaced if worn or damaged. The indicia 120 may also include conversion charts, common geometric shapes for tracing, or even customizable templates for specific projects. The indicia 120 on the work surface 104 may also incorporate a grid system or modular attachment points that align with the indicia 120, allowing for the precise placement of materials and tools. Advantageously, the indicia 120 serves to increase the functionality and user-friendliness of the stowable workstation 100, making it a more comprehensive solution for a variety of precision tasks, all within arms-reach of the user.

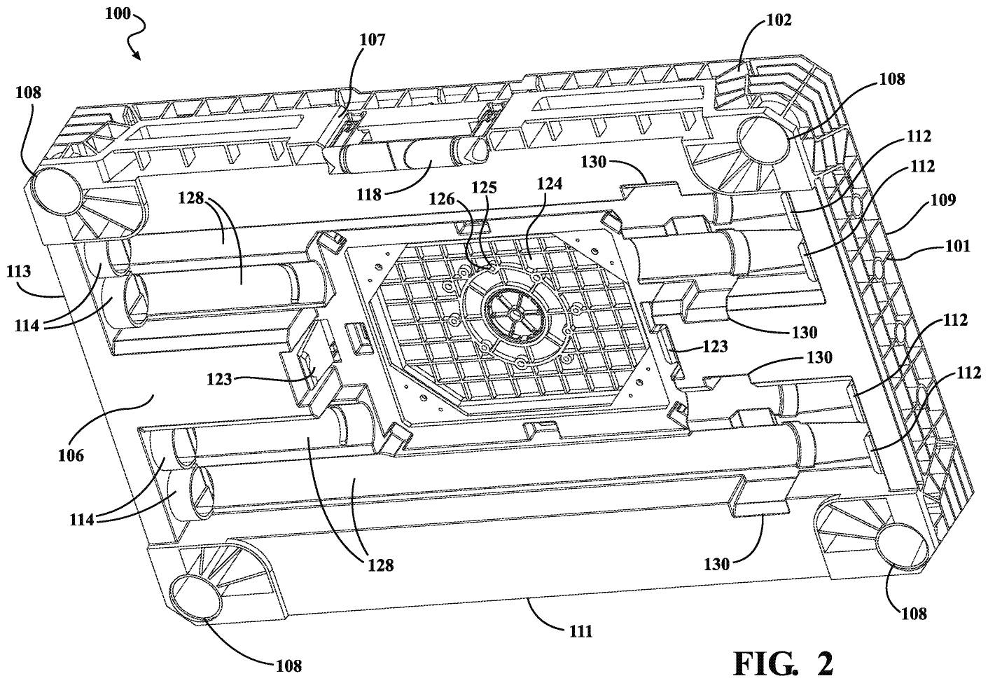

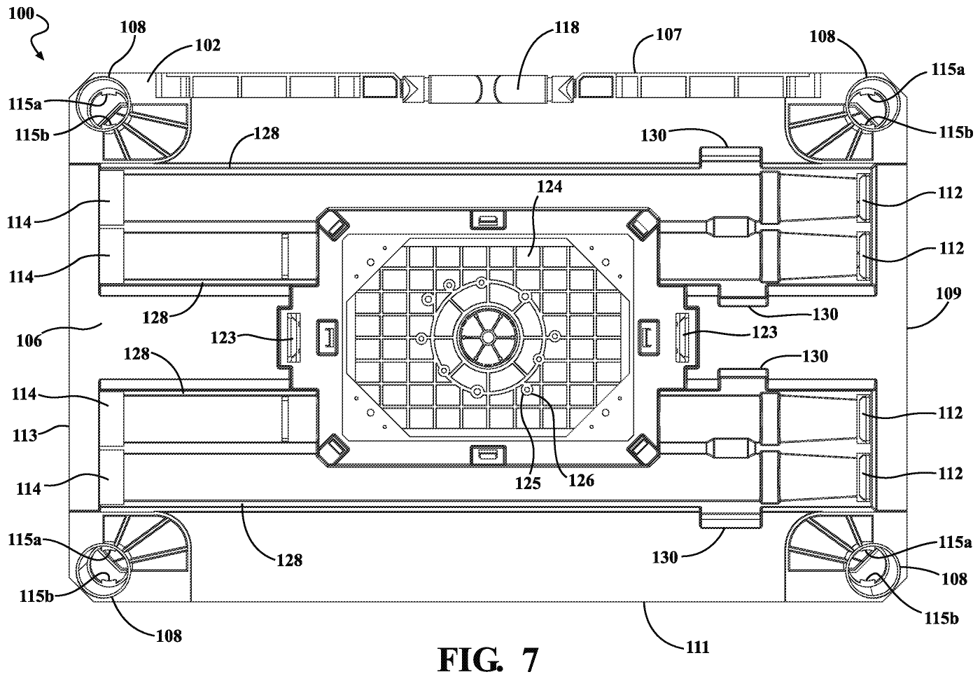

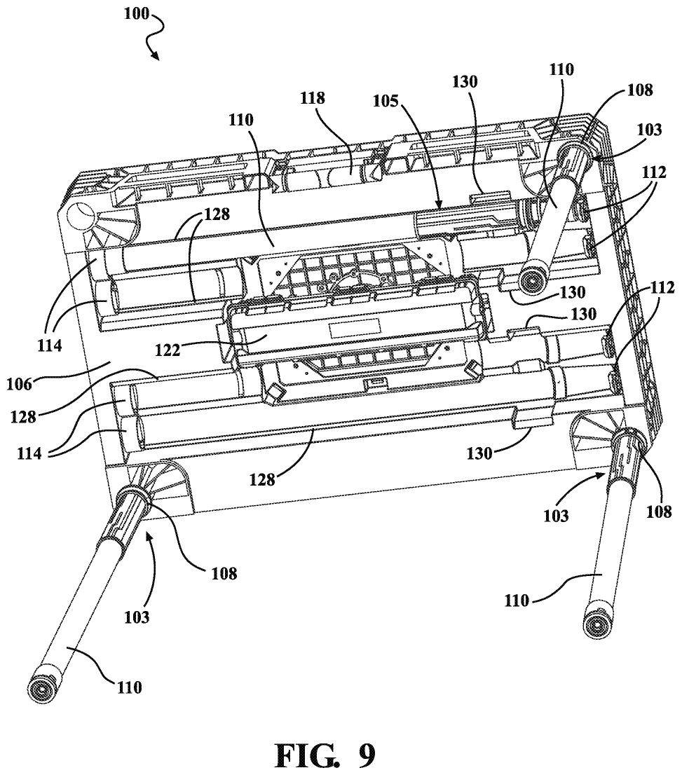

The stowing surface 106 may include the following aspects. The stowable surface may be defined by an area bordered by the first sidewall 107, the second sidewall 109, the third sidewall 111, and the fourth sidewall 113, opposite the work surface 104, as shown in FIGS. 2 and 7. More specifically, the stowing surface 106 may include a plurality of elongated recesses 128 extending along a portion of the stowing surface 106. The elongated recesses 128 are configured to receive the legs 110 when the plurality of legs 110 is in the stowed position 105, with reference to FIG. 9. For example, each of the legs 110 may be configured to snap into a respective one of the elongated recesses 128. As a non-limiting example, the stowing surface 106 may include a first elongated recess, a second elongated recess, a third elongated recess, and a fourth elongated recess. The first elongated recess and the second elongated recess may be spaced apart from the third elongated recess and the fourth elongated recess by the mounting plate 124. Each of the second elongated recess and the third elongated recess may be intersected by the mounting plate 124, as shown in FIG. 2, cutting out a portion of the second elongated recess and the third elongated recess.

The stowing surface 106 may further include cavities 130 disposed adjacent to each of the elongated recesses 128, as shown in FIGS. 2, 7, and 9. The cavities 130 may be configured to allow the user to insert their fingers to remove the legs 110 from the elongated recesses 128. The cavities 130 may be rectangular in shape, designed to allow four fingers to be inserted in the cavities 130. One of ordinary skill in the art may select suitable cavities 130 to dispose in the stowing surface 106.

With continued reference to FIGS. 2, 7, and 9, the stowing surface 106 of the stowable workstation 100 may include a plurality of snap fasteners 112 coupled to the stowing surface 106 of the tabletop 102. The snap fasteners 112 may be disposed on one side of the stowing surface 106, as a non-limiting example, shown in FIG. 7. More specifically, the snap fasteners 112 may be disposed on one end of each of the elongated recesses 128 to receive each of the legs 110 when in the stowed position 105, as further described. Particularly, the snap fasteners 112 may be configured to receive the ends of the legs 110 which are coupled to the tabletop 102 when the legs 110 are in the supporting position 103. The snap fasteners 112 may be configured to receive the flanged end 116 of each of the legs 110, as described herein. The snap fasteners 112 may be integrally formed within the stowing surface 106 or may be coupled to the stowing surface 106 by a press fit, snap fit, adhesive, and/or fastener. The snap fasteners 112 are configured to secure the plurality of legs 110 to the stowing surface 106 when the legs 110 are in the stowed position. Each of the snap fasteners 112 may include a tab that protrudes outward and provides a tight fit when each leg 110 is snapped into place. One of ordinary skill in the art may select suitable snap fasteners 112 within the scope of the present disclosure.

The stowing surface 106 may also include a plurality of leg receptacles 114 configured to receive the plurality of legs 110 when in the stowed position 105, as shown in FIGS. 2, 7, and 9. The leg receptacles 114 may be configured to complement and cooperate with the cross-sectional shape of the legs 110 when in the stowed position 105. More specifically, the leg receptacles 114 may be configured to receive the ends of the legs 110 which contact the floor when the stowable workstation 100 is in use and the legs 110 are in the supporting position 103. The leg receptacles 114 may be disposed directly opposite the plurality of snap fasteners 112, providing a secure and compact storage configuration for the legs 110. The snap fasteners 112 and the leg receptacles 114 may work together to hold each leg 110 of the plurality of legs when stored in the stowing surface 106 and in the stowed position 105. More specifically, the leg receptacles 114 may be positioned on the opposite end of each of the elongated recesses 128 from the snap fasteners 112. The leg receptacles 114 may be integrally formed within the stowing surface 106 or may be coupled to the stowing surface 106 by a press fit, snap fit, adhesive, and/or fastener. In operation, the user may place one end of each leg 110 into the leg receptacle 114 and snap the other end into the snap fastener 112 disposed opposite the leg receptacle 114 in the stowing surface 106. Advantageously, the elongated recesses 128 keep the legs 110 stored in the stowing surface providing a relatively flat bottom surface due to the placement of the leg receptacles 114 and the snap fasteners 112. As a non-limiting example, the leg receptacles 114 may be any shape configured to receive a similar shape of the legs 110. One of ordinary skill in the art may select a suitable leg receptacle 114 within the scope of the present disclosure.

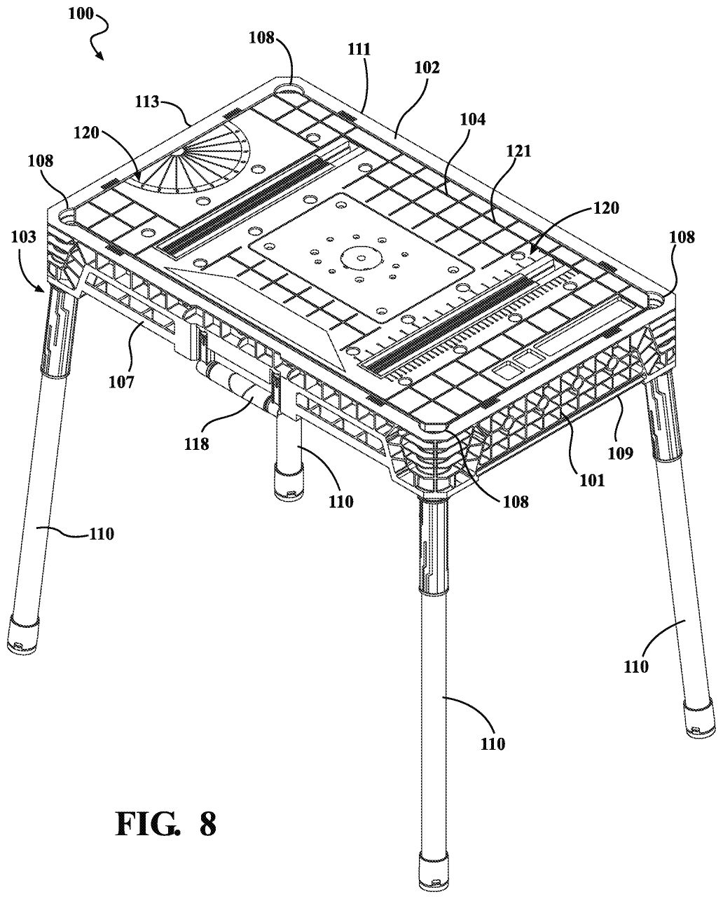

The plurality of receiving apertures 108 may include the following aspects. The receiving apertures 108 may be circular in shape, as a non-limiting example. The receiving apertures 108 may be shaped substantially similar to the shape of the legs 110 received. As described herein, the flanged end 116 of each of the legs 110 is received by one of the receiving apertures 108. The receiving apertures 108 may each be disposed on a corner of the tabletop 102, as shown in FIGS. 1-2 and 6-9. Advantageously, this provides a table-like configuration in the supporting position 103, as shown in FIG. 8. The receiving apertures 108 may include a first receiving aperture, a second receiving aperture, a third receiving aperture, and a fourth receiving aperture, each disposed on a corner of the tabletop 102. Each receiving aperture 108 may further include one or more tabs 115 disposed within the receiving aperture 108, as shown in FIG. 7. The one or more tabs 115 may be configured to provide a locking function when one of the legs 110 is received in the receiving aperture 108, as shown and described herein. The tab 115 in the receiving aperture 108 may include a first tab 115a and a second tab 115b. The first tab 115a may be positioned across the receiving aperture opposite to the second tab 115b, as shown in FIG. 7. The tabs 115 may further be substantially rectangular in shape, as each tab 115 protrudes outward from within the receiving aperture 108.

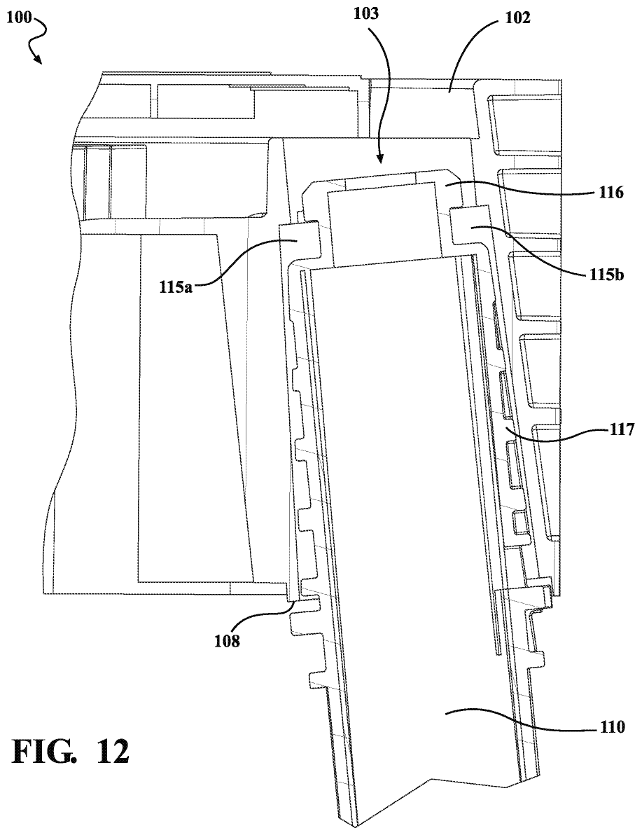

The plurality of legs 110 may include the following aspects. The legs 110 are elongated and manufactured of plastic, as a non-limiting example. One of ordinary skill in the art may select suitable materials to manufacture the legs 110 within the scope of the present disclosure. Each leg 110 of the plurality of legs may include a flanged end 116, configured and designed to twist-lock into a corresponding receiving aperture 108 of the tabletop 102 when the legs 110 are in the supporting position 103. The legs 110 may also include a raised reinforcement 117, as shown in FIG. 12, directly connected to the flanged end 116. The raised reinforcement 117 may provide improved contact between the leg 110 and the receiving aperture 108, including where the raised reinforcement 117 provides structural integrity while minimizing surface friction and surface area contact between the leg 110 and the receiving aperture 108.

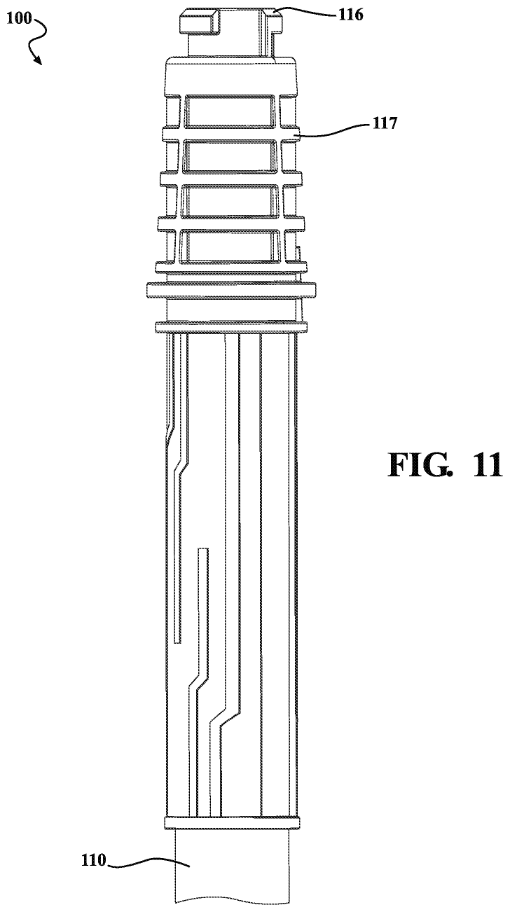

As shown in FIG. 11, the flanged end 116 may be configured to be received by the receiving apertures 108 of the tabletop 102. More specifically, the flanged end 116 may be configured to couple to the tabs 115 of the receiving apertures 108. Advantageously, the twist-lock capability provides stability and ease of assembly, allowing the user to easily assemble the stowable workstation 100 in the supporting position 103 or the stowed position 105. The user may place one of the legs 110 into one of the receiving apertures 108 and twist the leg 110 clockwise to allow the flanged end 116 to engage the tabs 115 of the receiving aperture 108. The leg 110 may be twisted counterclockwise to disengage from the tab 115 and the leg removed from the receiving aperture 108. One of ordinary skill in the art may select a suitable twist-lock configuration of the legs 110 within the scope of the present disclosure. As specifically shown in FIG. 12, the flanged end 116 is disposed above the tabs 115 of the receiving apertures 108, thereby holding the legs 110 in place in the supporting position 103.

The supporting position 103 of the tabletop 102 may include the following aspects. The supporting position 103 includes when the legs 110 are received through each of the receiving apertures 108. More specifically, the legs 110 hold the tabletop 102 in an upright position, as shown in FIG. 8. Advantageously, this allows the user to utilize the work surface 104 of the tabletop 102 as the stowable workstation 100 is secured in place. Each leg 110 of the plurality of legs 110 may extend outward at an angle relative to the stowable workstation 100 when the plurality of legs 110 is in the supporting position 103, as shown in FIG. 8. In another embodiment, the plurality of legs 110 may extend perpendicular relative to the tabletop 102. One of ordinary skill in the art may select a suitable configuration of the supporting position 103. With reference to FIG. 9, three legs 110 are shown in the supporting position 103, where each of these legs 110 are received by the receiving apertures 108.

The stowed position 105 may include the following aspects. The stowed position 105 may include where the legs 110 are in the stowed position 105 via the snap fasteners 112 and the leg receptacles 114. Advantageously, this allows the stowable workstation 100 to be put away in storage or in the rolling toolbox, as described herein, and shown in FIG. 13. Desirably, the stowed position 105 provides a slim and stowable device that is able to be stored quickly and efficiently, as well as save storage space. The stowed position 105 also provides a contiguous surface relative to the stowing surface 106, which allows the stowable workstation 100 to be stored without any obstructions. With reference to FIG. 9, one leg 110 is in the stowed position 105, which is shown to be held within one of the elongated recesses 128 by the snap fastener 112 and the leg receptacle 114. Advantageously, the stowed position 105 may be configured to secure four legs 110 in the stowed position 105 and the stowing surface 106 may be configured to receive four legs 110 to be placed in the stowed position 105, as described herein. More specifically, as shown in FIG. 7, there may be four elongated recesses 128. Each of the elongated recesses 128 may be capable of receiving a leg 110, for configuring the four legs 110 in the stowed position 105.

In certain embodiments, the stowable workstation 100 may also include a toolbox 122, as shown in FIG. 9. The toolbox 122 may be configured to be removably coupled to the stowing surface 106 of the tabletop 102. More specifically, the toolbox 122 may be coupled via one or more clips 123 disposed on or formed in the stowing surface 106, as shown in FIG. 2. Advantageously, the inclusion of the toolbox 122 adds functionality to the stowable workstation 100 by providing a convenient storage solution for tools and accessories, which can be easily accessed during use. The toolbox 122 may be centrally disposed and coupled to the stowing surface 106. The toolbox 122 may also be disposed beneath the mounting plate 124, when the legs 110 are in the stowed position 105. Further, the toolbox 122 may be disposed between the elongated recesses 128. The toolbox 122 may be manufactured of plastic. One of ordinary skill in the art may select a suitable toolbox 122 to couple to the stowing surface 106 within the scope of the present disclosure.

In certain embodiments, a work system 200 is provided, as shown in FIGS. 13-17. The work system 200 may include the stowable workstation 100, as described herein, and a rolling toolbox 202. The rolling toolbox 202 may include one or more wheels 204, a hollow body 206, and a lid 208. The lid 208 may be coupled to the hollow body 206. The lid 208 may further include a recess 210 formed therein, which may be configured to receive the tabletop 102 of the stowable workstation 100 when the legs 110 are in the stowed position 105. The stowable workstation 100 may sit in the recess 210 of the lid 208 without the use of any attachment mechanisms. Advantageously, the stowable workstation 100 may sit comfortably within the recess 210 to provide an easy and efficient means to quickly remove the stowable workstation 100 when needed. The stowable workstation 100 may also be configured to be stored within the recess 210 in the lid 208 by an attachment mechanism to securely transport the stowable workstation 100 received in the lid 208 of the rolling toolbox 202 when the stowable workstation 100 is in the stowed position. More specifically, the attachment mechanism may include one or more snap fittings, latches, or clamps, as non-limiting examples. One of ordinary skill may select suitable attachment mechanisms to secure the stowable workstation 100 within the recess 210 within the scope of the present disclosure. Desirably, the work system 200 provides a simple and convenient portable working configuration for the user which provides the stowable workstation 100 for working on the work surface 104 as well as a rolling toolbox 202 to stow the stowable workstation 100 when not in use, and further store other tools and equipment in the hollow body 206 of the rolling toolbox 202.

The hollow body 206 of the rolling toolbox 202 may be manufactured of plastic and may be injection molded. One of ordinary skill in the art may select a suitable material to form the rolling toolbox 202 within the scope of the present disclosure. The hollow body 206 may include a container defined by several walls. More specifically, the hollow body 206 may include a first wall 218, a second wall 220, a third wall 222, and a fourth wall 224, as well as a bottom wall 226.

The rolling toolbox 202 may further include a handle 212. This handle 212 may be disposed on a side of the rolling toolbox 202, providing the user with a means to easily maneuver the rolling toolbox 202 across various surfaces, thereby improving the portability of the entire work system 200. The handle 212 may be elongated and disposed along the entirety of the side of the rolling toolbox 202. The handle 212 may be manufactured of metal. Alternatively, the handle 212 may be manufactured of plastic. One of ordinary skill in the art may select a suitable handle 212 within the scope of the present disclosure.

In certain embodiments, the handle 212 may be designed with an ergonomic shape to reduce strain on the user's hand and wrist during transport, especially when the rolling toolbox 202 is heavily loaded. The handle 212 may also be configured to be retractable, telescopic, or foldable to minimize the space it occupies when not in use, making storage more convenient. The surface of the handle 212 may include a non-slip grip, such as rubber or textured plastic, to ensure a secure hold even in wet or slippery conditions. For added versatility, the handle 212 may also be adjustable in length to accommodate users of different heights, enhancing comfort and control during movement. Advantageously, the handle 212 enhances the user experience as it provides control and leverage in maneuvering the rolling toolbox 202.

The rolling toolbox 202 may further include a set of wheels 214, comprising a first wheel 214a and a second wheel 214b, as shown in FIGS. 13-15. The first wheel 214a and the second wheel 214b may be disposed on a lower end 207 of the rolling toolbox 202, facilitating the rolling motion and transport of the rolling toolbox 202. The wheels 214 may be connected via an axle 215, providing the first wheel 214a and the second wheel 214b parallel to one another. Advantageously, the wheels 214 facilitate easy transportation of the rolling toolbox 202 even when the hollow body 206 is loaded with heavy tools and equipment.

As a non-limiting example, the wheels 214 may be made of a durable plastic or rubber compound to provide traction and smooth rolling on different types of surfaces, from workshop floors to outdoor terrain. The wheels 214 may also feature a tread pattern designed to minimize slipping and enhance control. Alternatively, the wheels 214 may be designed as caster wheels, providing the ability to pivot and turn the rolling toolbox 202 with ease, which is particularly useful in tight spaces. For enhanced durability, the wheels 214 may be made with a solid core or feature a puncture-proof design to prevent deflation when rolling over sharp objects. The wheels 214 may include a locking mechanism that prevents rotation thereof to secure the rolling toolbox 202 in place when stationary. More specifically, the locking mechanism can militate against movement of the rolling toolbox 202 when the stowable workstation 100 is stored in the lid 208 of the rolling toolbox 202. Additionally, the size of the wheels 214 may be varied; larger wheels may be used to navigate over obstacles more easily, while smaller wheels might be preferred for compactness and storage considerations. These options provide the user with the rolling toolbox 202 that is not only portable but also adaptable to various work environments and user preferences.

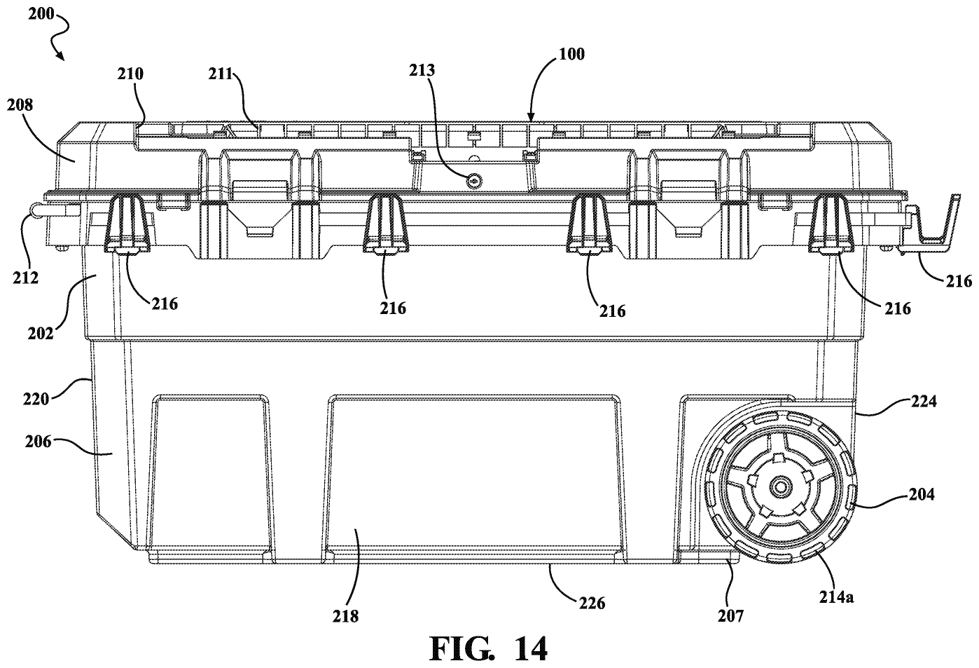

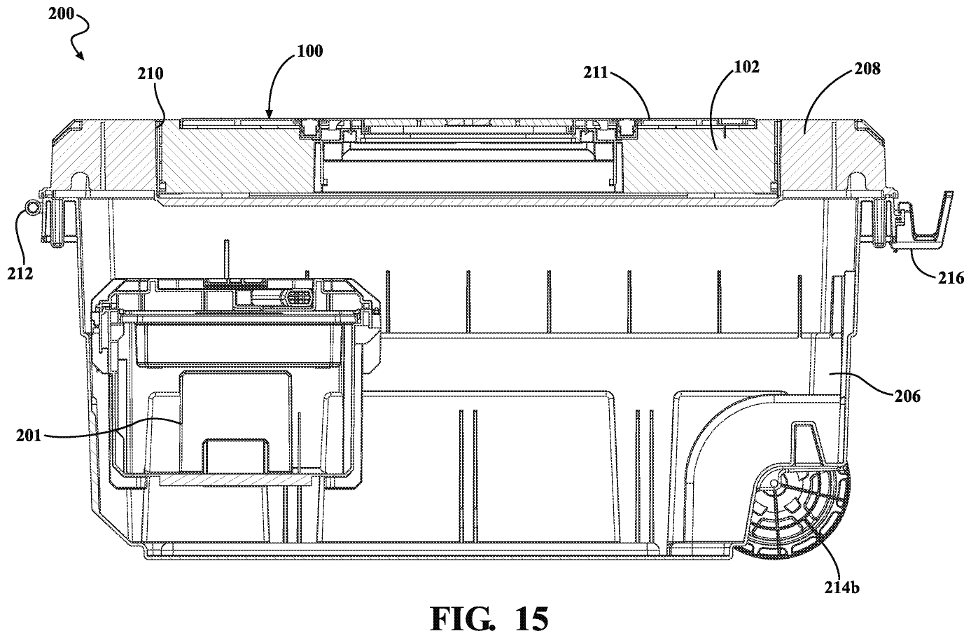

The rolling toolbox 202 may also include a lock 213, with reference to FIGS. 13-14 and 17. The lock 213 may be disposed on the lid 208. Alternatively, the lock 213 may be disposed on the hollow body 206. As shown in FIGS. 13 and 14, the lock 213 is disposed on the lid 208 of the rolling toolbox 202 and may be configured to couple the lid 208 to the hollow body 206 of the rolling toolbox 202. Advantageously, the lock 213 may be configured to be operated with a combination or a key configured to be received by the lock 213 to unlock the lid 208 from the hollow body 206 or the lock the lid 208 to the hollow body 206. Advantageously, the lock 213 keeps the contents in the hollow body secured. As a non-limiting example, the hollow body 206 may house a smaller toolbox 201, as shown in FIG. 15, which may be secured when the lock 213 is engaged.

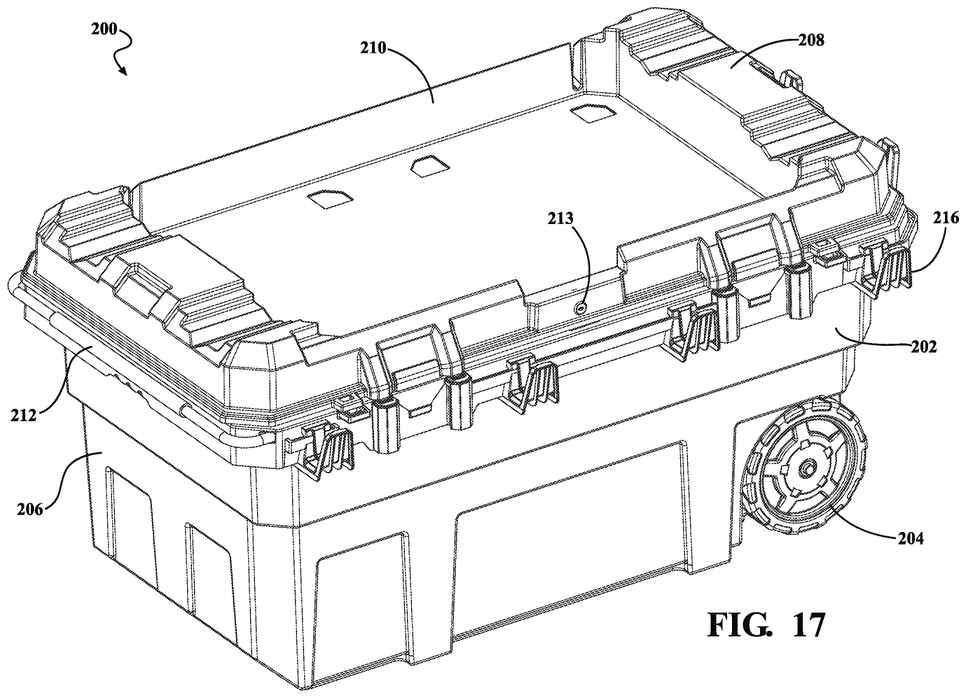

The lid 208 of the rolling toolbox 202 may include the recess 210, which may be formed in the lid 208 of the rolling toolbox 202 and may be substantially rectangular in shape, as shown in FIG. 17. The shape of the lid 208 may be designed to conform to the shape of the tabletop 102 of the stowable workstation 100 and vice versa, ensuring a secure fit and complementary proportions when the stowable workstation 100 is placed within the recess 210. Advantageously, the stowable workstation 100 easily connects and may be placed within the lid 208 of the rolling toolbox 202, which provides a transportable work system 200. The lid 208 of the rolling toolbox 202 may also be configured to be coupled to the hollow body 206 using a plurality of latches 216. These latches 216 provide a secure means of attaching the lid 208 to the hollow body 206, ensuring that the contents of the rolling toolbox 202 remain protected and the stowable workstation 100 stays in place during transport or when not in use. The latches 216 may be disposed on the hollow body 206 of the rolling toolbox 202. More specifically, the latches 216 may couple the lid 208 to the hollow body 206 as each of the latches is connected to the hollow body 206 on one end. In certain embodiments, the latches 216 may be disposed on the lid 208 and may be configured to couple the lid 208 to the hollow body 206 of the rolling toolbox 202. One of ordinary skill in the art may select suitable latches 216 to couple the lid 208 to the hollow body 206 of the rolling toolbox 202 within the scope of the present disclosure.

In certain embodiments, the recess 210 of the lid 208 may include a material such as foam or rubber to prevent rattling in transport and absorb impact of the stowable workstation 100 when the stowable workstation 100 is inserted or removed from the lid 208. The recess 210 may also include adjustable or removable dividers that allow the space to be customized according to the size of the stowable workstation 100 or other items that need to be transported and placed in the lid 208 of the rolling toolbox. One of ordinary skill in the art may select a suitable lid 208 within the scope of the present disclosure.

In addition to latches 216, alternative fastening mechanisms such as twist locks, snap-fit closures, or magnetic clasps may be employed to secure the lid 208 to the hollow body 206, offering varying levels of security and ease of access. For added convenience, the latches 216 may be designed to be operable with one hand or to automatically lock when the lid is closed. Furthermore, the lid 208 may incorporate a weather seal around the perimeter of the recess 210 to protect against dust, moisture, and other environmental elements, ensuring that the contents within the rolling toolbox 202 and the stowable workstation 100 are well-preserved regardless of external conditions. Advantageously, this provides a secure work system 200 that is tailored to the demands of different work environments and user needs.

The work system 200 may be configured such that the work surface 104 of the tabletop 102 of the stowable workstation 100 forms a contiguous surface 211 with a portion of the lid 208 of the rolling toolbox 202. This configuration may be achieved when the plurality of legs 110 of the stowable workstation 100 is in the stowed position and the stowable workstation 100 is received in the recess 210 of the lid 208. The resulting contiguous surface 211 provides an extended work area that is both stable and functional. Additionally, as shown in FIG. 13, the work system 200 may provide a substantially planar surface with the perimeter of the lid 208 when the stowable workstation 100 is received in the recess 210 of the lid 208 of the rolling toolbox 202. In certain embodiments, the work system 200 need not provide a substantially planar surface with the perimeter of the lid 208. Rather, the recess 210 of the lid 208 may be provided along a portion or an entirety of the lid 208, and the stowable workstation 100 may be received by the recess 210 of the lid, as it protrudes outward from the lid 208. One of ordinary skill in the art may select a suitable configuration for the recess 210 in the lid 208 to stow the stowable workstation 100 within the scope of the present disclosure.

A method 300 of using the stowable workstation 100 is also provided, as shown in FIG. 18. The method involves a step 302 of providing the stowable workstation 100, as described herein, and a step 304 of coupling the plurality of legs 110 to the stowing surface 106 of the tabletop 102, placing the legs 110 in the stowed position 105. The method 300 may also include a step 306 of coupling the legs 110 to the receiving apertures 108 of the tabletop 102, placing the legs 110 in the supporting position 103. The method 300 may further include a step 308 of de-coupling the plurality of legs 110 from the stowing surface 106 of the tabletop 102, as well as a step 310 of de-coupling the plurality of legs 110 from the plurality of receiving apertures 108 of the tabletop 102.

A method 400 of using the work system 200 is also provided, as shown in FIG. 19. The method 400 includes a step 402 of providing the work system 200, as described herein. The method 400 may further include a step 403 of coupling the plurality of legs 110 to the stowing surface 106 of the tabletop 102 prior to receiving the tabletop 102 of the stowable workstation 100 into the recess 210 of the lid 208. The method 400 may further include a step 404 of receiving the tabletop 102 of the stowable workstation 100 into the recess 210 of the lid 208, thereby loading the stowable workstation 100 onto the rolling toolbox 202. The method 400 may further include a step 406 of removing the tabletop 102 of the stowable workstation 100 from the recess 210 of the lid 208, ultimately unloading the stowable workstation 100 from the rolling toolbox 202. The method 400 may also include a step 407 of de-coupling the plurality of legs 110 from the stowing surface 106 of the tabletop 102 after removing the tabletop 102 of the stowable workstation 100 from the recess 210 of the lid 208.

Advantageously, the stowable workstation 100 and work system 200 may be portable, easily assembled and disassembled, and versatile in functionality. The stowable workstation 100, with its removably coupled legs and snap fasteners, allows for quick transition between a stable working setup and a compact stowed position, addressing the need for space efficiency and convenience in transportation. The indicia 120 on the work surface 104, the integrated toolbox 122, and the mounting plate 124 each enhance the stowable workstation 100, enabling users to keep tools and equipment organized and within reach. Furthermore, the inclusion of a rolling toolbox 202 with a recess 210 in the work system 200 specifically designed to accommodate the stowable workstation 100 ensures that the entire system can be effortlessly moved and securely stored, thus overcoming the limitations of bulkiness and lack of mobility.

### EXAMPLES

Example embodiments of the present technology are provided with reference to the several figures enclosed herewith.

With reference to FIGS. 1-12, a first embodiment of the stowable workstation 100 is shown, as described in Example 1.

### Example 1: Formation of the Workstation

To form the stowable workstation, a user begins by placing the tabletop with its work surface facing downwards. The plurality of legs, each with a flanged end, are then aligned with the corresponding receiving apertures on the underside of the tabletop. The user twists each leg so that the flanged ends lock into place within the receiving apertures via the tabs, securing the legs in the supporting position. Once all legs are attached, the workstation is stable and ready for use with the work surface facing upwards and each of the legs in the supporting position. The handle on the sidewall of the tabletop can be extended to facilitate positioning of the workstation in the desired location. If additional functionality is required, the user can attach the toolbox to the stowing surface and mount tools onto the mounting plate via the coupling means.

With reference to FIGS. 1-12, the stowable workstation 100 is shown, as described in Example 2.

### Example 2: Disassembly to the Stowed Position

When disassembling the workstation for storage, the user first ensures that the handle is in the nonextended position to avoid obstruction. The user then proceeds to twist each leg to disengage the flanged ends from the tabs of the receiving apertures. Once all legs are detached, they are aligned with the leg receptacles on the stowing surface of the tabletop. The legs are then secured to the stowing surface using the snap fasteners, ensuring that each leg is firmly held in place within the stowing surface. The toolbox, if previously attached, is removed from the stowing surface. Alternatively, the toolbox may be secured to the stowing surface after the each of the legs are properly stowed in the stowing surface. The workstation is now in a compact, stowed position, with the legs neatly stored and the work surface protected, making it convenient for transport or storage.

With reference to FIGS. 13-17, the work system 200 is shown, as described in Example 3.

### Example 3: Stowing the Workstation in the Rolling Toolbox

To stow the workstation within the rolling toolbox, the user first ensures that the workstation is in the stowed position with the legs secured to the stowing surface. The lid of the rolling toolbox is closed, and the recess is prepared to receive the tabletop. The user then places the stowable workstation into the recess of the lid, with the work surface facing up. The workstation fits snugly within the rectangular recess, and the contiguous surface of the lid and the stowing surface of the tabletop provides an extended flat area. The lid is then secured to the hollow body of the toolbox using the latches. With the workstation now stowed within the rolling toolbox, the entire system can be easily transported to different locations using the handle and wheels on the toolbox, providing a mobile and efficient work environment.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A stowable workstation, comprising:
a tabletop having a work surface, a stowing surface, and a plurality of receiving apertures disposed in the tabletop; and
a plurality of legs configured to be removably coupled to the tabletop in a supporting position and in a stowed position, the supporting position having the plurality of legs coupled to the plurality of receiving apertures of the tabletop, and the stowed position having the plurality of legs coupled to the stowing surface of the tabletop.

2. The stowable workstation of claim 1, further including a plurality of snap fasteners coupled to the stowing surface of the tabletop, the plurality of snap fasteners configured to hold the plurality of legs to the stowing surface of the tabletop when the plurality of legs is in the stowed position.

3. The stowable workstation of claim 2, wherein the stowing surface includes a plurality of leg receptacles configured to receive the plurality of legs when the plurality of legs is in the stowed position, the plurality of leg receptacles disposed opposite the plurality of snap fasteners.

4. The stowable workstation of claim 1, wherein each leg of the plurality of legs includes a flanged end, the flanged end configured to twist-lock into a receiving aperture of the plurality of receiving apertures in the supporting position.

5. The stowable workstation of claim 1, wherein the tabletop includes a handle disposed along a sidewall of the tabletop.

6. The stowable workstation of claim 5, wherein the handle is configured to move between an extended position and a nonextended position relative to the sidewall of the tabletop.

7. The stowable workstation of claim 1, wherein the work surface includes indicia, the indicia including one of a predefined length measurement, a predefined angle measurement, and combinations thereof.

8. The stowable workstation of claim 1, further including a toolbox, the toolbox configured to be removably coupled to the stowing surface of the tabletop.

9. The stowable workstation of claim 1, wherein the tabletop includes a mounting plate removably disposed to cover a passthrough of the tabletop.

10. The stowable workstation of claim 9, wherein the mounting plate includes coupling means configured to mount a tool to the mounting plate.

11. A work system, comprising:
a stowable workstation including:
a tabletop having a work surface, a stowing surface, and a plurality of receiving apertures disposed in the tabletop; and
a plurality of legs configured to be removably coupled to the tabletop in a supporting position and in a stowed position, the supporting position having the plurality of legs coupled to the plurality of receiving apertures of the tabletop, and the stowed position having the plurality of legs coupled to the stowing surface of the tabletop; and
a rolling toolbox including:
at least one wheel;
a hollow body; and
a lid configured to be coupled to the hollow body, the lid having a recess formed therein, the recess configured to receive the tabletop of the stowable workstation when the plurality of legs of the stowable workstation is in the stowed position.

12. The work system of claim 11, wherein the rolling toolbox includes a handle disposed on a side of the rolling toolbox.

13. The work system of claim 11, wherein the at least one wheel includes a first wheel and a second wheel disposed on a lower end of the rolling toolbox.

14. The work system of claim 11, wherein the recess formed in the lid is substantially rectangular in shape.

15. The work system of claim 11, wherein the work surface of the tabletop of the stowable workstation is configured to form a contiguous surface with a portion of the lid of the rolling toolbox when the plurality of legs of the stowable workstation is in the stowed position and the stowable workstation is received in the recess of the lid.

16. The work system of claim 11, wherein the lid of the rolling toolbox is configured to be coupled to the hollow body using a plurality of latches.

17. A method of using a stowable workstation, comprising:
providing a stowable workstation according to claim 1; and
performing one of:
coupling the plurality of legs to the stowing surface of the tabletop, thereby placing the plurality of legs in the stowed position; and
coupling the plurality of legs to the plurality of receiving apertures of the tabletop, thereby placing the plurality of legs in the supporting position.

18. The method of claim 17, further including performing one of:
de-coupling the plurality of legs from the stowing surface of the tabletop; and
de-coupling the plurality of legs from the plurality of receiving apertures of the tabletop.

19. A method of using a work system, comprising:
providing a work system according to claim 11; and
performing one of:
receiving the tabletop of the stowable workstation into the recess of the lid, whereby the stowable workstation is loaded onto the rolling toolbox; and
removing the tabletop of the stowable workstation from the recess of the lid, whereby the stowable workstation is unloaded from the rolling toolbox.

20. The method of claim 19, further including performing one of:
coupling the plurality of legs to the stowing surface of the tabletop prior to receiving the tabletop of the stowable workstation into the recess of the lid; and
de-coupling the plurality of legs from the stowing surface of the tabletop after removing the tabletop of the stowable workstation from the recess of the lid.
